(19) United States
(12) Patent Application Publication
(10) Pub. No.: US 2013/0252071 A1
(43) Pub. Date: Sep. 26, 2013

(54) BATTERY

(71) Applicant: KABUSHIKI KAISHA TOSHIBA, Minato-ku (JP)

(72) Inventors: Ryuuichi TERAMOTO, Yokohama-shi (JP); Takahiro Terada, Yokohama-shi (JP); Kuniaki Yamamoto, Yokohama-shi (JP); Noboru Koike, Saku-shi (JP); Satoshi Wada, Fuchu-shi (JP)

(73) Assignee: KABUSHIKI KAISHA TOSHIBA, Minato-ku (JP)

(21) Appl. No.: 13/842,638

(22) Filed: Mar. 15, 2013

(30) Foreign Application Priority Data
Mar. 22, 2012 (JP) 2012-066061

(51) Int. Cl. H01M 2/30; H01M 10/02; H01M 2/02

(52) U.S. Cl. CPC H01M 2/307; H01M 2/0237; H01M 10/02
USPC 429/156; 429/211; 429/179

(57) ABSTRACT

According to one embodiment, a battery includes, an electrode body includes a positive electrode plate, a negative electrode plate, and an insulating separator disposed between the positive and negative electrode plates, a lead electrically connected to the electrode body, and a metal terminal includes a cavity electrically connected to the lead at any one point.

### CROSS-REFERENCE TO RELATED APPLICATIONS

This application is based upon and claims the benefit of priority from Japanese Patent Application No. 2012-066061, filed Mar. 22, 2012, the entire contents of which are incorporated herein by reference.

### FIELD

Embodiments described herein relate generally to a battery.

### BACKGROUND

Secondary batteries are widely used as power sources for electric vehicles, hybrid electric vehicles, and electric bicycles or for electronic apparatuses. For example, lithium-ion secondary batteries, non-aqueous secondary batteries, have become noticeable as power sources for electric vehicles and the like, since they have high output power and high energy density.

In general, a secondary battery is constructed as a cell comprising an outer casing of aluminum or the like, an electrode group, and electrode terminals. The outer casing is in the form of a flat rectangular box. The electrode group is accommodated together with an electrolyte in the outer casing. The electrode terminals are disposed on the outer casing and connected to the electrode group.

Further, the capacity and output power are increased by using an assembled battery or secondary battery device (or battery) comprising the assembled battery and an electric circuit attached thereto. The assembled battery comprises a plurality of cells arranged side by side in a case and connected in parallel or series.

In batteries, case-side terminals are expected to be precisely connected to leads on electrode bodies.

### BRIEF DESCRIPTION OF THE DRAWINGS

FIG. 1 is a perspective view showing an external appearance of a secondary battery device according to an embodiment;

FIG. 2 is an exploded perspective view showing the structure of the secondary battery device;

FIG. 3 is a sectional view showing the structure of terminal areas of the secondary battery device;

FIG. 4 is an explanatory diagram showing an assembly process for the secondary battery device;

FIG. 5 is an explanatory diagram showing the assembly process for the secondary battery device;

FIG. 6 is an explanatory diagram showing the structure of a secondary battery device according to another embodiment and an assembly process therefor;

FIG. 7 is an explanatory diagram showing the structure of the secondary battery device and the assembly process therefor;

FIG. 8 is a sectional view showing the structure of terminal areas of the secondary battery device;

FIG. 9 is an explanatory diagram showing an assembly process for a secondary battery device according to still another embodiment;

FIG. 10 is an explanatory diagram showing a welding process for the secondary battery device;

FIG. 11 is an explanatory diagram showing a sealing process for the secondary battery device; and

FIG. 12 is a plan view showing the structure of a terminal of the secondary battery device.

### DETAILED DESCRIPTION

In general, according to one embodiment, a battery comprises, an electrode body comprising a positive electrode plate, a negative electrode plate, and an insulating separator disposed between the positive and negative electrode plates, a lead electrically connected to the electrode body, and a metal terminal comprising a cavity electrically connected to the lead at any one point.

### First Embodiment

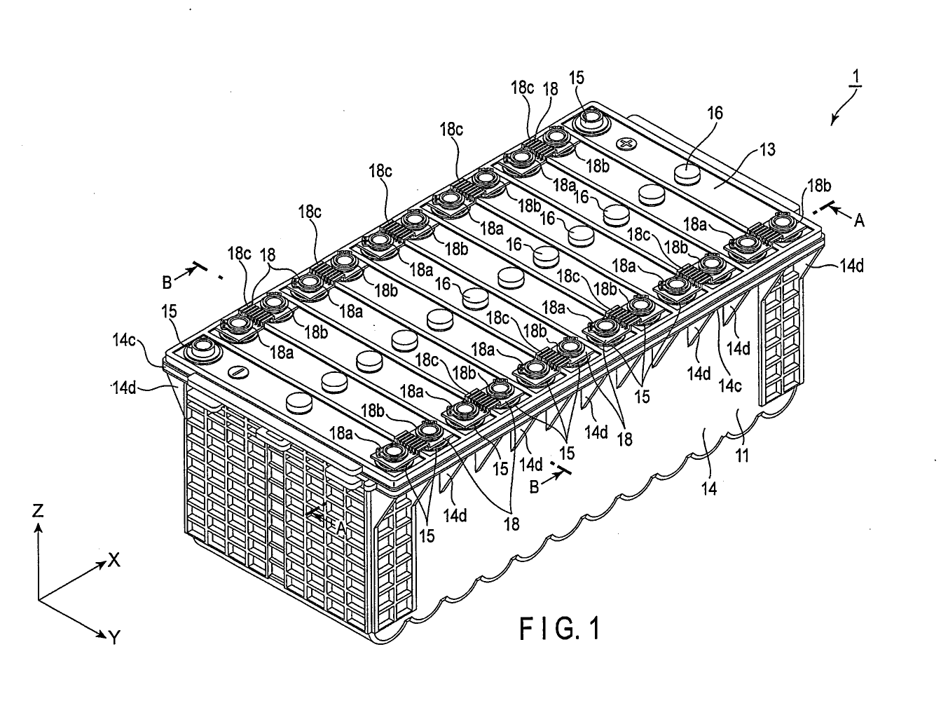

A secondary battery device 1 according to a first embodiment will now be described with reference to FIGS. 1 to 5. In these drawings, arrows X, Y and Z indicate three orthogonal directions, individually, and some structural elements are enlarged or reduced in scale or omitted for ease of illustration.

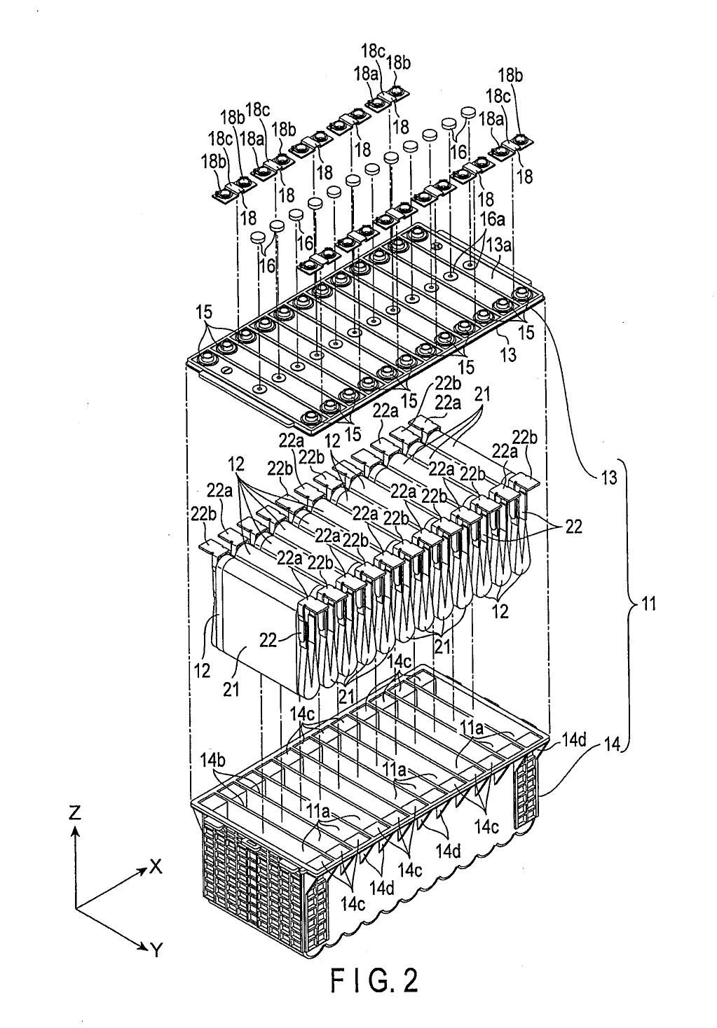

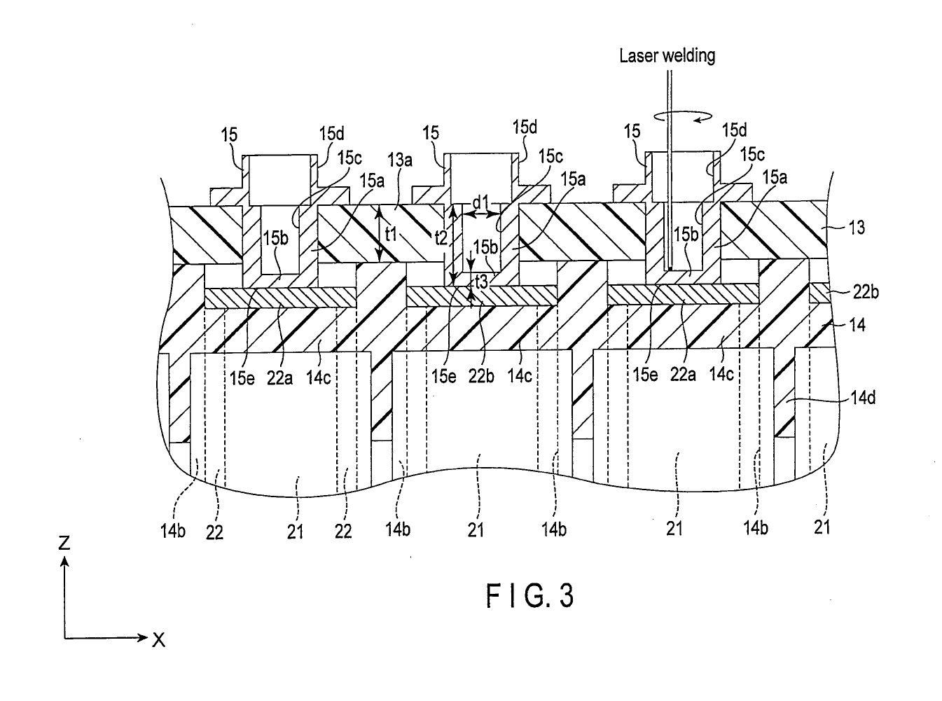

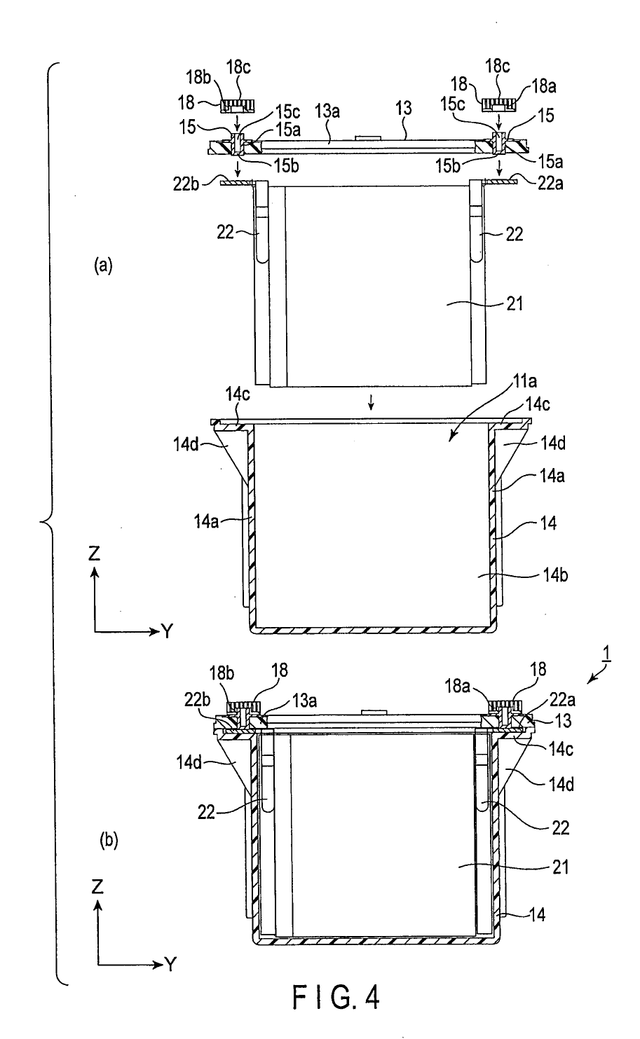

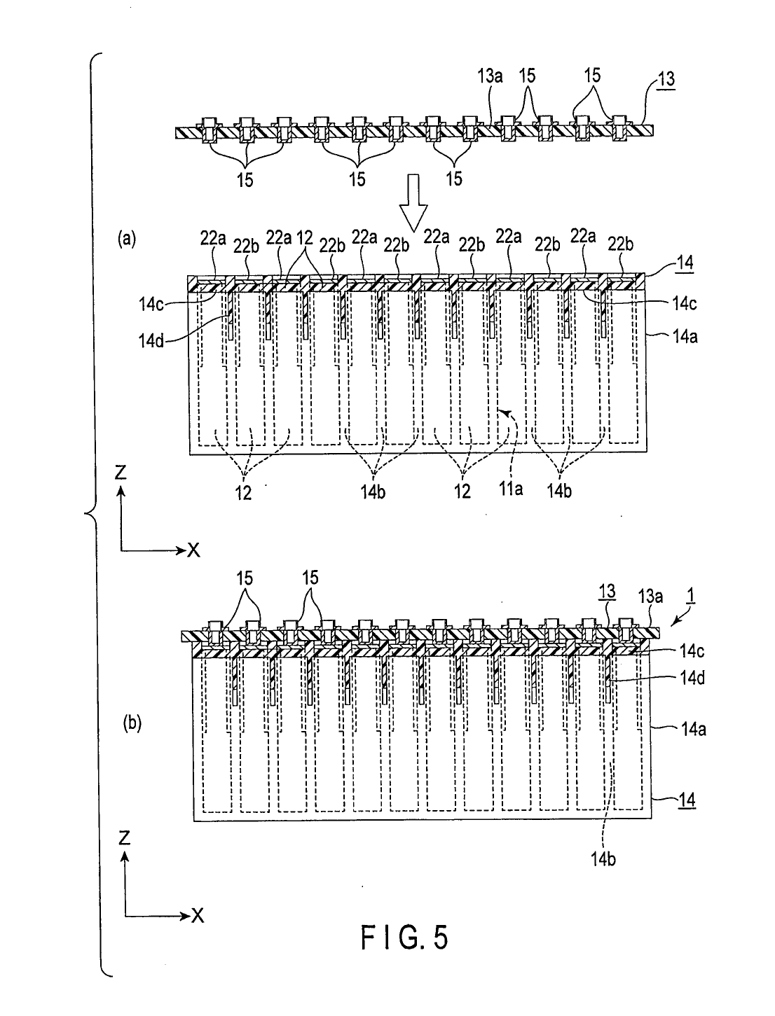

FIG. 1 is a perspective view showing an external appearance of the secondary battery device (battery) according to the embodiment. FIG. 2 is an exploded perspective view. FIG. 3 is a sectional view of terminal areas taken along line A-A of FIG. 1; FIG. 4 is a sectional view taken along line B-B of FIG. 1, showing the internal structure and an assembly process; and FIG. 5 is a sectional view taken along line A-A of FIG. 1.

As shown in FIGS. 1 and 2, the secondary battery device 1 comprises a battery case 11, in which a plurality of divided spaces are formed, and a plurality of electrode groups 12 accommodated together with a non-aqueous electrolyte in the case 11. The secondary battery device 1 is constructed as an assembled battery which comprises a plurality of secondary battery units serving as secondary battery. In the present embodiment, each of the electrode groups 12 comprises an electrode body and leads (for example, positive electrode lead 22a and negative electrode lead 22b shown in FIG. 2). The electrode body comprises a positive electrode plate and negative electrode plate, with an insulating separator therebetween. The leads are electrically connected individually to the positive and negative electrode plates of the electrode body.

The battery case 11 is in the form of a rectangular box, comprising first and second case members 13 and 14 on the upper and lower sides, respectively. The first and second case members 13 and 14 are assembled and sealed together to form a closed space in the battery case 11 that accommodates the electrode groups 12 together with the non-aqueous electrolyte.

Preferably, a thermoplastic (or amorphous) resin is used for the first and second case members 13 and 14. For example, the resin material may be modified polyphenylene ether [m-PPE]), which is an insulating synthetic resin.

The first case member 13 comprises a rectangular plate-like lid 13a, which is a resin molding constituting a ceiling wall that closes a top opening of the second case member 14. The first case member 13 has the functions of sealing accommodation sections 11a in the battery case 11 in a liquid-tight manner and preventing a short circuit through electrical insulation.

The first case member 13 comprises the lid 13a and a plurality of terminals 15 formed thereon by insert molding. In this case, the integrally molded terminals 15 correspond in number to the positive and negative electrode leads 22a and 22b of the accommodated electrode groups 12.

The terminals 15 serve to position the first case member 13 on the second case member 14 and assemble them together and are arranged on their corresponding positive and negative electrode leads 22a and 22b of the electrode groups 12.

As shown in FIG. 3, the terminals 15 are made of metal, such as aluminum. Each terminal 15 is, for example, circular in a plan view and integrally comprises a cylindrical side portion 15a and circular bottom portion 15b. It is recessed inward to form a hollow circular cavity 15c at the junction to the positive and negative electrode leads 22a and 22b.

The outer peripheral surface of the side portion 15a of the terminal 15 is formed integrally with the plastic first case member 13 by insert molding such that it is bonded and held. The bottom portion 15b is a thin-walled portion whose mediolateral thickness (in the direction of arrow Z) is smaller than that of the side portion 15a. The bottom portion 15b can be subjected to welding, such as laser welding, through the cavity 15c from the outer surface.

The laser welding should preferably be performed in a circular manner, so that the bottom portion 15b should preferably have a circular shape. Weld beads formed by laser welding are not limited to a circular shape and may have various other shapes, such as elliptical or polygonal shapes.

For example, plate thickness t1 of the lid 13a of the first case member 13 is set to about 4 mm; Z-direction thickness t2 of the side portion 15a of the terminal 15 to about 10 mm, inner diameter d1 of the cavity 15c to about 7 mm, and Z-direction thickness t3 of the bottom portion 15b to about 0.5 mm.

The terminal 15 penetrates the lid 13a of the first case member 13 so that its one Z-direction end projects to the outside of the first case member and is connected to a bus bar 18 and an external terminal and the other end projects inward and is connected to its corresponding electrode group 12.

Further, electrolyte injection holes 16a are formed in transverse central portions of the first case member 13 such that they are closed by sealing members 16, individually. Furthermore, a gas exhaust valve and the like are arranged on the first case member 13. The gas exhaust valve comprises a thin-walled portion formed by substantially halving the thickness of a part of the lid. If gas continues to be produced in the case in an abnormal mode such that the internal pressure is increased to a predetermined value or more, the gas exhaust valve is opened so that the internal pressure is reduced to prevent a failure, such as a rupture.

As shown in FIGS. 1, 2 and 4, the second case member 14 is a resin molding comprising an outer shell 14a, partition plates 14b, supporting portions 14c, and ribs 14d, which are integrally constructed by injection molding or the like. The outer shell 14a is in the form of an open-topped rectangular box. The partition plates 14b are arranged side by side in a first direction (X-direction in the drawings) in the outer shell 14a. The supporting portions 14c are arranged on top opening edges of the outer shell 14a. The ribs 14d serve to reinforce the supporting portions 14c.

The outer shell 14a is a box comprising the accommodation sections 11a arranged along the electrode groups 12 and opens on one end side (at the upper part in the drawings).

The partition plates 14b are arranged side by side so that they divide the internal space of the outer shell 14a into a plurality of parts in the Y-direction, thereby forming the accommodation sections 11a as many as the electrode groups 12 in parallel relation. In this case, 11 partition plates 14b on ZY-planes are arranged side by side in the X-direction. The partition plates 14b have the functions of positioning the electrode groups 12 and preventing a short circuit between the electrode groups 12 or members. The partition plates 14b define inside the outer shell 14a the accommodation sections 11a, which are divided from one another and open at one end. Each accommodation section 11a has an elongated rectangular shape corresponding to each electrode group 12 such that the electrode group 12 can be accommodated extending in the transverse direction (Y-direction) of the battery case 11.

The supporting portions 14c are plates that are individually arranged at transversely opposite ends of the opening edges of the outer shell 14a and project outward. The supporting portions 14c are arranged throughout the X-direction length of the opening edges on the opposite sides in the Y-direction, and are configured to individually support the positive and negative electrode leads 22a and 22b. The electrode leads 22a and 22b placed on the supporting portions 14c are sandwiched between the lid 13a and supporting portions 14c with the electrode groups 12 located in the accommodation sections 11a. The ribs 14d are triangular plates that connect the outer surface of the outer shell 14a and the lower surfaces of the supporting portions 14c, thereby reinforcing the supporting portions 14c.

Each electrode group 12 comprises a coil 21(electrode body) and the positive and negative electrode leads 22a and 22b that are led out on the opposite sides of the coil 21 and connected to current collectors 22 at the opposite ends.

The coil 21 is formed into a flat rectangular shape in such a manner that, for example, the positive and negative electrode plates are spirally wound with the insulating separator (not particularly shown) between them and further radially compressed. In this case, for example, lithium cobalt oxide and lithium titanate are used as the positive and negative electrode materials, respectively, of the coil 21.

The positive and negative electrode leads 22a and 22b are connected to the positive and negative electrode plates, respectively, of the coil 21 and disposed integrally with the current collectors 22 led out at the opposite ends of the coil 21, and they are made of metal, such as aluminum or copper. The positive and negative electrode leads 22a and 22b are plates that extend above the coil 21 and are bent so as to project transversely outward relative to the battery case 11 from the coil 21. The bottom portions 15b of the terminals 15 are connected individually to the positive and negative electrode leads 22a and 22b from above.

The positive and negative electrode leads 22a and 22b outwardly project to be sandwiched between the supporting portions 14c and lid 13a and connected to the bottom portions 15b with the coils 21 located individually in the accommodation sections 11a in the battery case 11.

The electrode groups 12 are oriented so that the positive and negative electrode leads 22a and 22b of each two adjacent electrode groups 12 are arranged alternately. The electrode groups 12 are electrically connected, for example, in series by a plurality of bus bars 18 for use as electrically conductive members through the terminals 15. In this embodiment, 11 bus bars 18 are located in predetermined positions and formed integrally with the first case member 13 so that the adjacent electrodes of 12 electrode groups 12 are connected in series.

Each bus bar 18 is a metal plate member of an electrically conductive material, such as aluminum, copper, or bronze, and integrally comprises a pair of terminal areas 18a and 18b. The one terminal area 18a of the bus bar 18 is electrically connected to the positive electrode lead 22a of each electrode group 12, and the other terminal area 18b to the negative electrode lead 22b of an adjoining electrode group 12. Also, these terminal areas 18a and 18b are electrically connected to each other. The 12 electrode groups 12 are connected in series by the bus bars 18. Alternatively, the electrode groups 12 may be connected in parallel.

The terminals 15 are connected to the negative electrode lead 22b of that one of the electrode groups 12 which is located at one end of the array and the positive electrode lead 22a of the electrode group 12 at the other end, and function as external output terminals.

Further, the bus bars 18 and a battery monitoring board (not shown), comprising a voltage control unit, voltage detector, temperature sensor, etc., are installed outside the first case member 13. Also, a lid (not shown) that covers the bus bars 18 and battery monitoring board is attached to the outside of the first case member 13.

A manufacturing method for the secondary battery device according to the present embodiment will now be described with reference to FIGS. 4 and 5. In an assembly process, as shown in FIGS. 4 and 5, the electrode groups 12 are first introduced individually into accommodation chambers of the second case member 14 on the lower side through the top opening, whereby they are assembled to the second case member 14. Thereupon, the positive and negative electrode leads 22a and 22b are located and supported on the supporting portions 14c on the opposite sides of the second case member 14.

When this is done, the positive and negative electrode leads 22a and 22b are connected individually to the terminals 15 that are disposed integrally with the second case member 14, whereupon the electrical connection and bonding/holding of the terminal areas are simultaneously performed, as shown in FIG. 3 and <b> of FIG. 5.

Then, a welding process, such as laser welding, is performed such that each terminal 15 and the positive and negative electrode leads 22a and 22b are bonded together. In doing this, as shown in FIG. 3, welding to the thin-walled bottom portion 15b can be performed through the cavity 15c from outside the case 11, so that the welding process can be easily accomplished with reliability. The battery manufactured by this welding process is formed with a welding trace on the outer surface (upper surface in the drawings) of the bottom portion 15b. In this case, for example, the welding trace is formed along a circular welding path on the outer surface of the bottom portion 15b. Since junctions between the terminal 15 and positive and negative electrode leads 22a and 22b are supported from below by the supporting portion 14c in positions deviated outward from the coil 21, moreover, the welding process can be stably performed, and an influence of laser radiation or the like on the coil 21 during the welding process can be avoided.

Subsequently, the opening edges of the first and second case members 13 and 14 are bonded and sealed together by thermal deposition or the like.

Thereafter, various processes, such as injection of the electrolyte, initial charge/discharge, etc., are sequentially performed, and finally, the terminals 15 outwardly projecting from the case 11 are connected in series by the bus bars 18. Thereupon, the secondary battery device 1 for use as an assembled battery is completed.

The secondary battery device and the manufacturing method therefor according to the present embodiment can provide the following effects. Specifically, the metal terminals 15 are disposed integrally on the plastic first case member 13, and the cavities 15c are arranged in positions corresponding to the leads. Thus, the process for assembling the battery case 11 and the connection of the terminal areas can be simultaneously performed, and the welding or other bonding process can be performed from outside the battery case 11. Further, the cavity 15c can be thin-walled so that the outer peripheral surface of the side portion 15a is wide. In this way, the cavity 15c can be easily externally bonded to the positive and negative electrode leads 22a and 22b while maintaining the bondability with the plastic case member 13 during the insert molding.

Since the case 11 integrally comprises the terminals 15, moreover, the electrode groups 12 can be arranged directly in the accommodation sections 11a in the case 11 so that their positive and negative electrode leads 22a and 22b are electrically connected to the terminals 15 as the case 11 is assembled. Thus, the assembly parts count can be reduced, and the assembly process can be simplified while maintaining high precision.

Further, the junctions between each terminal 15 and the positive and negative electrode leads 22a and 22b project on the opposite sides and are supported from below by the supporting portion 14c in positions deviated outward from the coil 21. Therefore, the welding process can be stably performed, and an influence of laser radiation or the like on the coil 21 during the welding process can be avoided.

### Second Embodiment

The structure of and a manufacturing method for a secondary battery device 2 according to a second embodiment will now be described with reference to FIGS. 5 to 8. In these drawings, arrows X, Y and Z indicate three orthogonal directions, individually, and some structural elements are enlarged or reduced in scale or omitted for ease of illustration.

In the present embodiment, each of terminals 15 comprises, in place of the thin-walled cavity 15c, a hole portion 115c that penetrates it in a mediolateral direction (indicated by arrow Z). In this arrangement, positive and negative electrode leads 22a and 22b are bent transversely inward, and a connector 23 is formed on each of the leads 22a and 22b such that it is inserted into the hole portion 115c for connection. In the present embodiment, moreover, a first case member 13 comprises partition plates 113b that define accommodation sections 11a, which are closed by a second case member 14. Since other structures are the same as those of the first embodiment, a repeated description thereof is omitted.

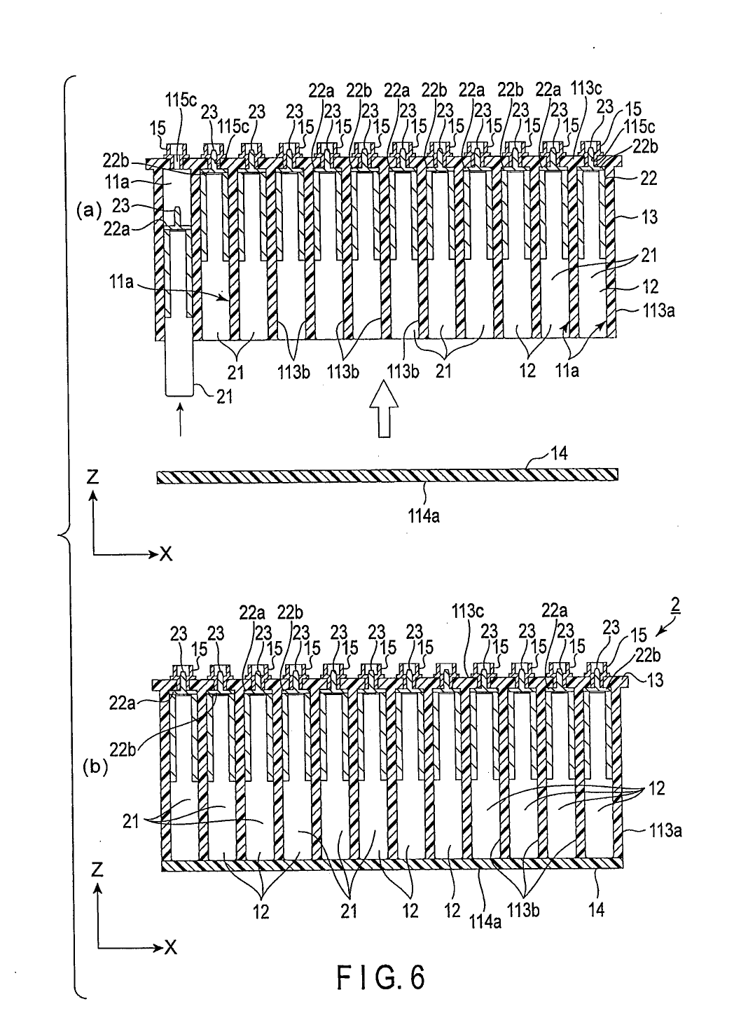

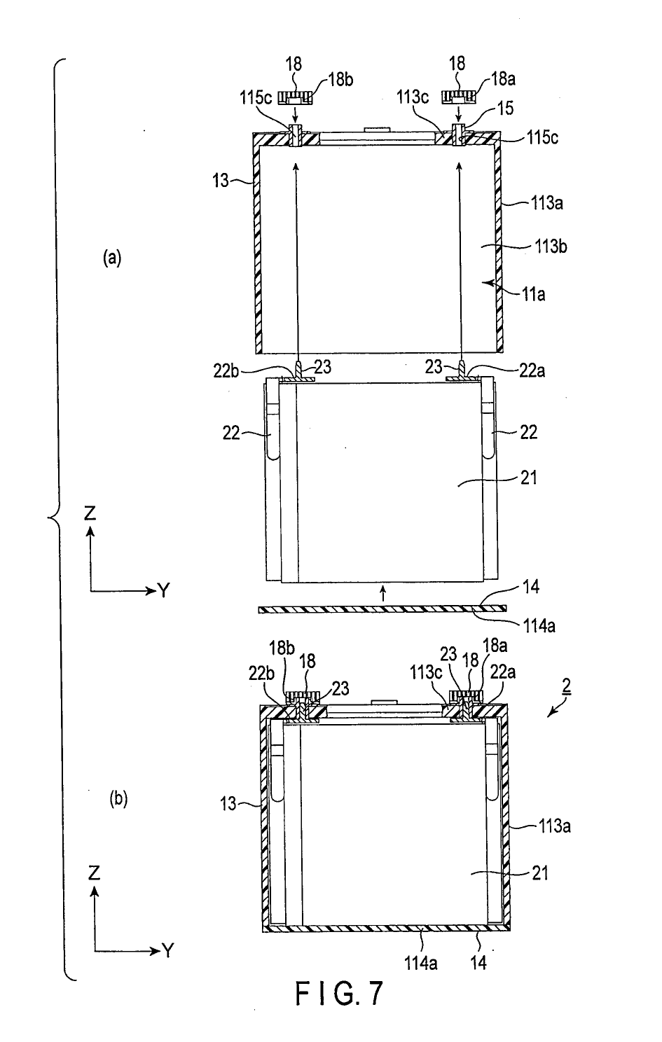

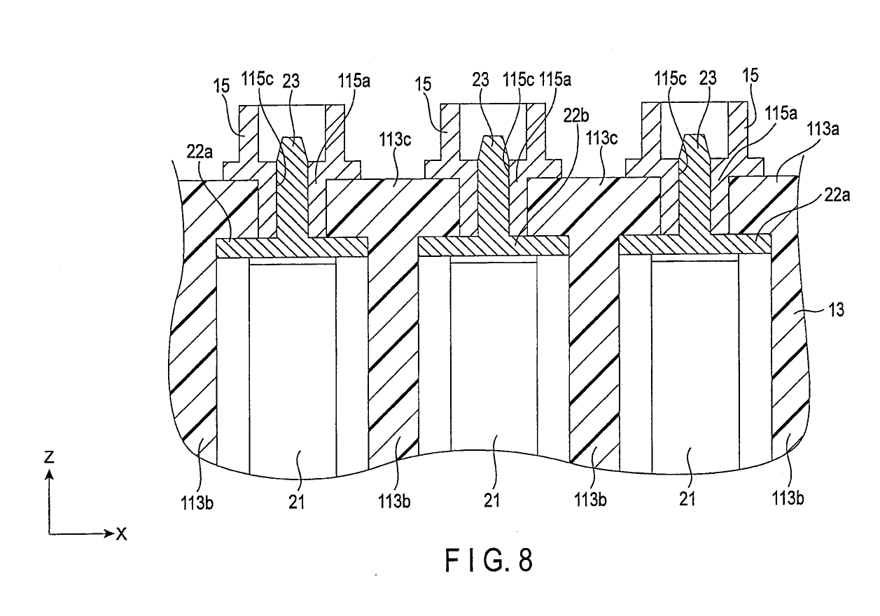

FIGS. 6 and 7 are explanatory diagrams showing the sectional configuration of the secondary battery device 2 and an assembly process, and FIG. 8 is an enlarged view showing terminal areas.

As shown in <b> of FIGS. 6 and 7, the secondary battery device 2, like the secondary battery device 1 of the first embodiment, comprises a battery case 11, in which a plurality of divided spaces are formed, and a plurality of electrode groups 12 accommodated together with a non-aqueous electrolyte in the battery case 11. Each of the electrode groups 12 is constructed as an assembled battery, which integrally comprises a plurality of secondary battery units serving as secondary batteries.

In the present embodiment, as in the foregoing first embodiment, each of the electrode groups 12 comprises an electrode body and leads (for example, positive electrode lead 22a and negative electrode lead 22b shown in FIG. 2 and <a> and <b> of FIG. 6). The electrode body comprises a positive electrode plate, negative electrode plate, and insulating separator between them. The leads are electrically connected individually to the positive and negative electrode plates of the electrode body. The battery case 11 is in the form of a rectangular box, comprising first and second case members 13 and 14 on the upper and lower sides, respectively. The first and second case members 13 and 14 are assembled and sealed together to form a closed space in the case 11 that accommodates the electrode groups 12 together with the non-aqueous electrolyte.

Preferably, a thermoplastic (or amorphous) resin is used for the first and second case members 13 and 14. For example, the resin material may be modified polyphenylene ether [m-PPE]), which is an insulating synthetic resin.

The first case member 13 comprises an outer shell 113a and the partition plates 113b, which are integrally constructed by injection molding or the like. The outer shell 113a is in the form of an open-bottomed rectangular box. The partition plates 113b are arranged side by side in a first direction (X-direction in the drawings) in the outer shell 113a. The outer shell 113a is shaped along the electrode groups 12 and opens on the other end side (at the lower part in the drawings).

The partition plates 113b are arranged side by side so that they divide the internal space of the outer shell 113a into a plurality of parts in the Y-direction, thereby forming the accommodation sections 11a as many as the electrode groups 12 in parallel relation. In this case, 11 partition plates 113b on ZY-planes are arranged side by side in the X-direction. The partition plates 113b have the functions of positioning the electrode groups 12 and preventing a short circuit between the electrode groups 12 or members. The partition plates 113b define inside the outer shell 113a the accommodation sections 11a, which are divided from one another and open downward. Each accommodation section 11a has an elongated rectangular shape corresponding to each electrode group 12 such that the electrode group 12 can be accommodated extending in the transverse direction (Y-direction) of the battery case 11.

A bottom portion 113c of the outer shell 113a integrally comprises the terminals 15 formed by insert molding. In this case, the integrally molded terminals 15 correspond in number to the positive and negative electrode leads 22a and 22b of the accommodated electrode groups 12.

The terminals 15 are arranged so that the connectors 23 on the positive and negative electrode leads 22a and 22b of the electrode groups 12 are inserted individually into their respective hole portions 115c the moment the electrode groups 12 are positioned and assembled to the first case member 13. The terminals 15 are made of metal, such as aluminum or copper. Each terminal 15 is, for example, circular in a plan view and comprises a cylindrical side portion 115a. It is formed with the hole portion 115c that penetrates it in the mediolateral direction at the junction between the positive and negative electrode leads 22a and 22b. The outer peripheral surface of the side portion 115a of the terminal 15 is formed integrally with the plastic first case member 13 by insert molding. The terminal 15 penetrates the bottom portion 113c of the first case member 13 so that its one Z-direction end projects to the outside of the first case member and is connected to a bus bar 18 and an external terminal.

As shown in FIG. 8, each electrode group 12 comprises a coil 21 and the positive and negative electrode leads 22a and 22b that are led out on the opposite sides of the coil 21. The coil 21, like that of the first embodiment, is formed into a flat rectangular shape in such a manner that, for example, the positive and negative electrode plates are spirally wound with the insulating separator (not particularly shown) between them and further radially compressed. In this case, for example, lithium cobalt oxide and lithium titanate are used as the positive and negative electrode materials, respectively, of the coil 21.

The positive and negative electrode leads 22a and 22b are connected to the positive and negative electrode plates, respectively, of the coil 21 and disposed integrally with current collectors 22 led out at the opposite ends of the coil 21, and they are made of metal, such as aluminum or copper. The positive and negative electrode leads 22a and 22b are plates that extend above the coil 21 and are bent so as to project transversely inward relative to the battery case 11 above the coil 21. The columnar connectors 23 individually protrude upward from the electrode leads 22a and 22b toward the first case member 13.

In the present embodiment, the connectors 23 are inserted into their corresponding hole portions 115c and bonded to their inner surfaces, whereupon they are electrically connected to the terminals 15 and positive and negative electrode leads 22a and 22b.

The second case member 14 comprises a rectangular plate-like lid 114a, which closes a bottom opening of the first case member 13, and seals the accommodation sections 11a in the battery case 11 in a liquid-tight manner.

The electrode groups 12 of the secondary battery device 2, like those of the secondary battery device 1 of the first embodiment, are oriented so that the positive and negative electrode leads 22a and 22b of each two adjacent electrode groups 12 are arranged alternately. The electrode groups 12 are electrically connected, for example, in series by a plurality of bus bars 18 for use as electrically conductive members through the terminals 15.

A manufacturing method for the secondary battery device according to the present embodiment will now be described with reference to FIGS. 6 and 7. In an assembly process, as shown in FIGS. 6 and 7, the electrode groups 12 are first introduced individually into the accommodation sections 11a in the first case member 13 on the upper side through the bottom opening, whereby they are assembled to the first case member 13. Thereupon, the upwardly projecting connectors 23 are inserted into their corresponding hole portions 115c of the terminals 15 that are disposed integrally with the first case member 13, above the positive and negative electrode leads 22a and 22b, individually. Thus, electrical connection and bonding of the terminals 15 and leads 22a and 22b are simultaneously performed.

Then, a welding process, such as laser welding, is performed such that each terminal 15 and the positive and negative electrode leads 22a and 22b are bonded together.

In doing this, welding to the bonded regions can be performed through the hole portion 115c from outside the case 11, so that the welding process can be easily accomplished with reliability. The battery manufactured by this welding process is formed with a welding trace on an outer surface (upper surface in the drawings) around the hole portion 115c.

Subsequently, the second case member 14 is assembled to the first case member 13 so as to close its bottom opening, and their opening edges are bonded and sealed together by thermal deposition or the like. As in the case of the first embodiment, moreover, various processes, such as injection of the electrolyte, initial charge/discharge, etc., are sequentially performed, and finally, the terminals 15 outwardly projecting from the case 11 are connected in series by the bus bars 18. Thereupon, the secondary battery device 2 for use as an assembled battery is completed.

The secondary battery device 2 and the manufacturing method therefor according to the present embodiment can provide the same effects as in the first embodiment. Specifically, the metal terminals 15 are disposed integrally on the plastic first case member 13, and the hole portions 115c are arranged in positions corresponding to the respective connectors 23 of the positive and negative electrode leads 22a and 22b. Thus, the process for assembling the battery case 11 and the connection of the terminal areas can be simultaneously performed, and the welding process can be performed from outside the case 11. Since the case 11 integrally comprises the terminals 15, moreover, the electrode groups 12 can be arranged directly in the accommodation sections 11a in the case 11 so that their positive and negative electrode leads 22a and 22b are electrically connected to the terminals 15 as the case 11 is assembled. Thus, the assembly parts count can be reduced, and the assembly process can be simplified while maintaining high precision.

Further, positioning can be facilitated and reliable bonding can be achieved by inserting the projecting connectors 23 into the hole portions 115c.

### Third Embodiment

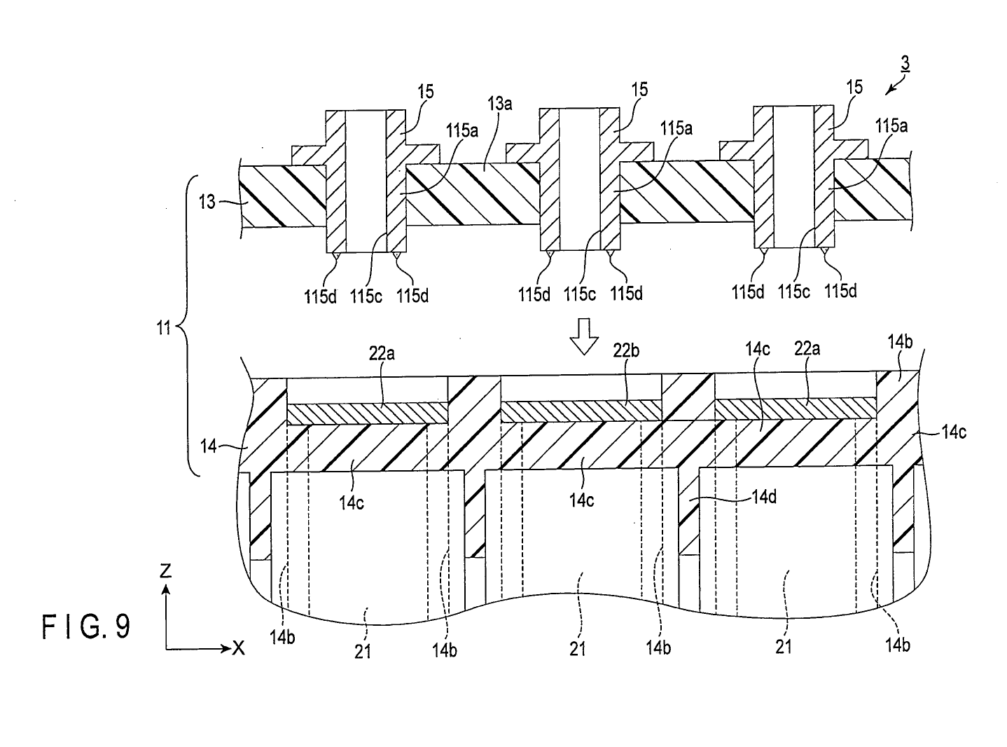

The structure of and a manufacturing method for a secondary battery device 3 according to a third embodiment will now be described with reference to FIGS. 9 to 12. In these drawings, arrows X, Y and Z indicate three orthogonal directions, individually, and some structural elements are enlarged or reduced in scale or omitted for ease of illustration.

In the present embodiment, each of terminals 15 comprises, in place of the thin-walled cavity 15c, a hole portion 115c that penetrates it in a mediolateral direction, and the respective upper surfaces of plate-like positive and negative electrode leads 22a and 22b are resistance-welded. Since other structures are the same as those of the first embodiment, a repeated description thereof is omitted.

In the present embodiment, as shown in FIGS. 9 to 11, the terminals 15 are made of metal, such as aluminum or copper. Each terminal 15 is, for example, circular in a plan view and comprises a cylindrical side portion 115a. It is formed with the hole portion 115c that penetrates it in the mediolateral direction at the junction between the positive and negative electrode leads 22a and 22b. The outer peripheral surface of the side portion 115a of the terminal 15 is formed integrally with a plastic first case member 13 by insert molding. The terminal 15 penetrates a lid 13a of the first case member 13 so that its one Z-direction end projects to the outside of the first case member and is connected to a bus bar 18 and an external terminal.

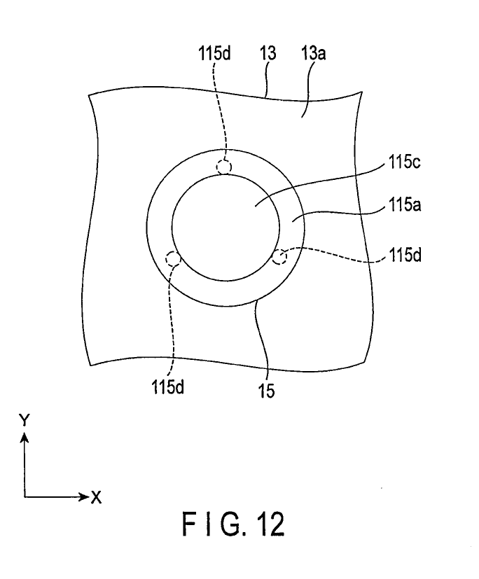

Further, projections 115d for spot welding protrude inward (downward in the drawings) from the inner end surface of each terminal 15. As shown in FIG. 12, the projections 115d are arranged individually at three spots equally spaced at 120° on, for example, a cylindrical side peripheral portion.

The manufacturing method for the secondary battery device according to the third embodiment will now be described with reference to FIGS. 9 to 11. Since processes other than a welding process are the same as those of the first embodiment, a description thereof is omitted.

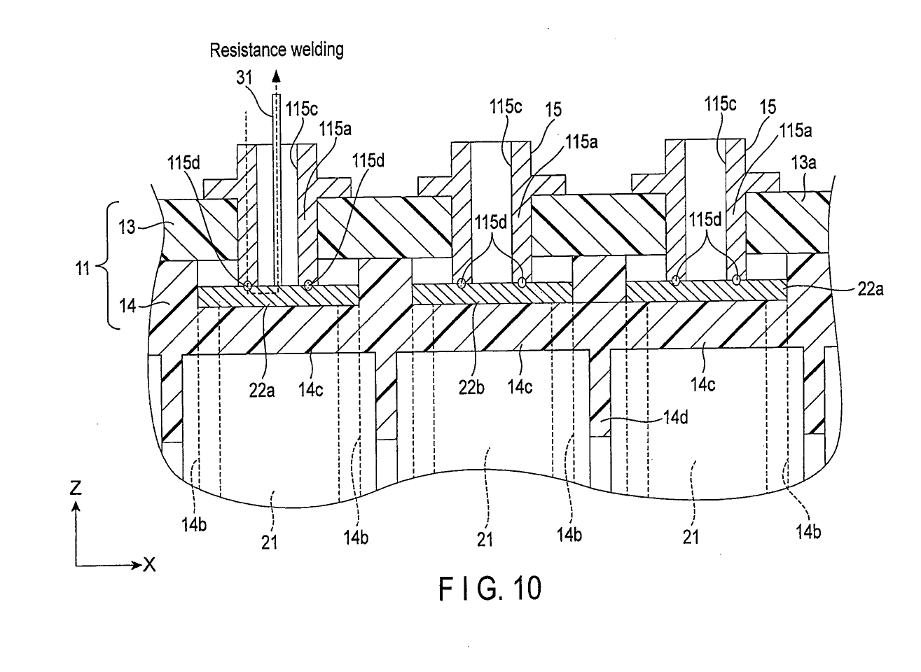

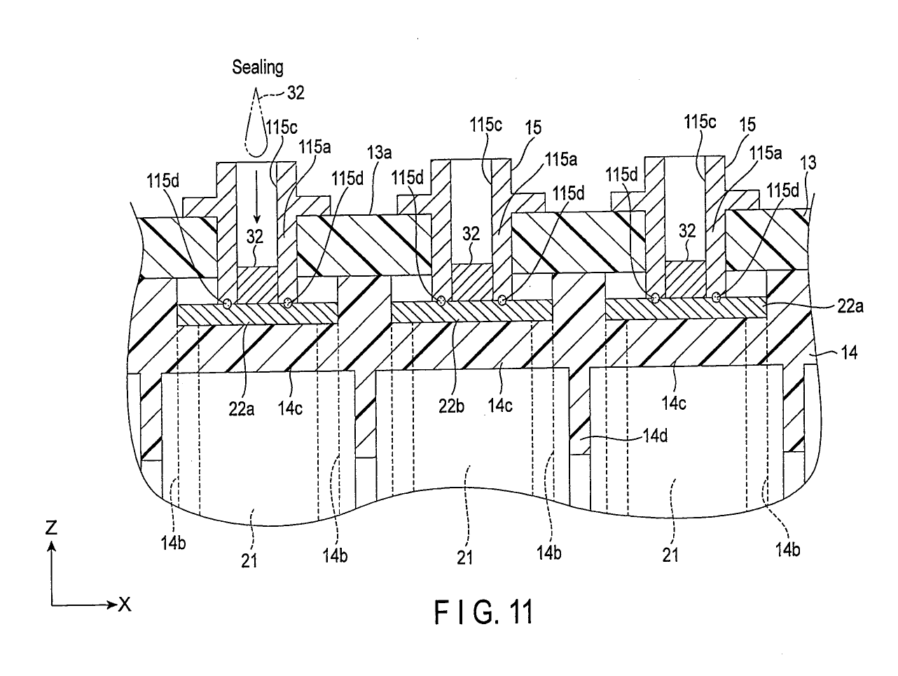

When electrode groups 12 are assembled to the first case member 13 in an assembly process, as shown in FIG. 9, the projections 115d abut the positive and negative electrode leads 22a and 22b. If current is passed through an electrode 31 located in the hole portion 115c in this state, as shown in FIG. 10, the projections 115d are electrified and melted by resistance heat. Thereupon, the leads 22a and 22b and terminals 15 are spot-welded. Further, an electrically conductive sealant 32, such as a low-melting metal, is filled into each hole portion 115c from outside a case 11 to achieve sealing and electrical connection, as shown in FIG. 11, whereupon the welding process is completed.

In the present embodiment, as in the foregoing first and second embodiments, each of the electrode groups 12 comprises an electrode body and leads (for example, positive and negative electrode leads 22a and 22b shown in FIGS. 1 and 9). The electrode body comprises a positive electrode plate, negative electrode plate, and insulating separator between them. The leads are electrically connected individually to the positive and negative electrode plates of the electrode body.

In this arrangement, resistance welding, filling of the sealant 32, etc., can be performed through the hole portion 115c from outside the case 11, so that the welding process can be easily accomplished with reliability. In the battery manufactured by this welding process, the sealant 32 is filled into the hole portion 115c. Subsequently, the opening edges of the first case member 13 and a second case member 14 are bonded and sealed together by thermal deposition or the like.

Thereafter, various processes, such as injection of the electrolyte, initial charge/discharge, etc., are sequentially performed, and finally, the terminals 15 outwardly projecting from the case 11 are connected in series by the bus bars 18. Thereupon, the secondary battery device 3 for use as an assembled battery is completed.

The secondary battery device 3 and the manufacturing method therefor according to the present embodiment can provide the same effects as in the first and second embodiments. Specifically, the metal terminals 15 are disposed integrally on the plastic first case member 13, and the terminals 15 are arranged in positions corresponding to the positive and negative electrode leads 22a and 22b. Thus, the process for assembling the battery case 11 and the connection of the terminal areas can be simultaneously performed, and the welding process can be performed from outside the case 11. Since the case 11 integrally comprises the terminals 15, moreover, the electrode groups 12 can be arranged directly in accommodation sections 11a in the case 11 so that their positive and negative electrode leads 22a and 22b are electrically connected to the terminals 15 as the case 11 is assembled. Thus, the assembly parts count can be reduced, and the assembly process can be simplified while maintaining high precision.

The embodiments described herein are exemplary only and are not limiting the scope of the invention, and specific configurations, materials, assembly procedure, etc., may be changed as required.

For example, the resin material used for the first and second case members 13 and 14 may be any of various materials other than m-PPE described before. Available materials for this purpose include, for example, olefin resins, such as PE, PP, and PMP; polyester resins, such as PET, PBT, and PEN; POM resins; polyamide resins, such as PA6, PA66, and PA12; crystalline resins, such as PPS and LCP, and their alloy resins; and noncrystalline resins, such as PS, PC, PC/ABS, ABS, AS, PES, PEI, and PSF, and their alloy resins. A laminated film may be used for the second case member. Further, materials for the positive and negative electrodes of the coil 21 and the terminals 15 are not limited to the above-described ones, and may be appropriately changed.

In the procedures described in the first and third embodiments, the upper first case member 13 is assembled after the electrode groups 12 are arranged in the accommodation sections 11a previously formed in the lower second case member 14. In the procedure described in the second embodiment, in contrast, the opening is closed by the second case member 14 after the electrode groups 12 are arranged in the accommodation sections 11a previously formed in the upper first case member 13. Alternatively, however, the structures of the terminals 15 and battery case 11 and the procedures may be combined oppositely in each of the embodiments.

In the process for arranging the electrode groups 12 in the accommodation sections 11a in the case members 13 and 14, the electrode groups 12 may be introduced one after another or collectively.

Although the electrode groups 12 are arranged, for example, side by side in a row in the first direction according to the embodiments described above, they may alternatively be arranged in a plurality of rows. In the above-described embodiments, moreover, the electrode groups 12 are connected in series to increase voltage. Alternatively, however, the electrode groups 12 may be arranged in parallel to increase the capacity, thereby forming an assembled battery. Furthermore, it is also applicable to a configuration in which a plurality of blocks each including some electrode groups 12 arranged in parallel are connected in series.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A battery comprising:
an electrode body comprising a positive electrode plate, a negative electrode plate, and an insulating separator disposed between the positive and negative electrode plates;
a lead electrically connected to the electrode body; and
a metal terminal comprising a cavity electrically connected to the lead at any one point.

2. The battery of claim 1, wherein the cavity is formed so that a region near a central portion thereof electrically connected to the lead is thinner-walled than a part of a side peripheral portion thereof, the central portion and the lead being electrically connected to each other by welding.

3. The battery of claim 1, wherein the cavity comprises a substantially flat central portion and a side peripheral portion formed substantially perpendicular to the central portion.

4. The battery of claim 3, wherein the inner surface of the side peripheral portion is substantially cylindrical, and the substantially flat central portion is substantially circular.

5. A battery comprising:
an electrode body comprising a positive electrode plate, a negative electrode plate, and an insulating separator disposed between the positive and negative electrode plates;
a lead electrically connected to the electrode body; and
a metal terminal comprising a through hole portion and a side peripheral portion electrically connected to the lead.

6. The battery of claim 1, further comprising a plastic first case member comprising the terminal and a plastic second case member which accommodates the electrode body.

7. The battery of claim 6, wherein the lead comprises a connector projecting on the first case member side when the lead is assembled to a battery case, the connector being configured to be inserted into a hole portion as the electrode body is assembled to the first case member.

8. The battery of claim 7, wherein the lead is electrically connected to the electrode body so as to project in an axial direction from the opposite side of the electrode body, and the second case member is in the form of a box with one end open, comprising supporting portions on the opposite side portions thereof which support the lead, and the terminal is electrically connected in positions where the supporting portions and the lead overlap one another.

9. A battery comprising:
a plurality of electrode bodies each comprising a positive electrode plate, a negative electrode plate, and an insulating separator disposed between the positive and negative electrode plates;
a plurality of leads electrically connected to the electrode bodies;
a plurality of metal terminals each comprising a cavity electrically connected to the lead corresponding thereto at a recessed portion;
a first case member comprising the metal terminals; and
a second case member which accommodates the electrode bodies.

10. A battery comprising:
a plurality of electrode bodies each comprising a positive electrode plate, a negative electrode plate, and an insulating separator disposed between the positive and negative electrode plates;
a plurality of leads electrically connected to the electrode bodies;
a plurality of metal terminals each comprising a through hole portion and a side peripheral portion electrically connected to the lead corresponding thereto;
a plastic first case member comprising the metal terminals; and
a second case member which accommodates the electrode bodies.
